(19) United States
(12) Patent Application Publication
(10) Pub. No.: US 2011/0270617 A1
(43) Pub. Date: Nov. 3, 2011

(54) LOYALTY, MEMBERSHIP AND IDENTIFICATION CARD SYSTEM, PROCESS AND COMPUTER PROGRAM

(76) Inventors: António Manuel PACHECO E MURTA, Porto (PT); Carlos Nuno ALVES DE OLIVEIRA, Porto (PT)

(21) Appl. No.: 12/770,002

(22) Filed: Apr. 29, 2010

(51) Int. Cl. G06Q 30/00; G06F 17/00

(52) U.S. Cl. 705/1.1; 235/380

(57) ABSTRACT

The present subject matter enables an user to sign-up and use a loyalty, membership and identification digital card; to associate a digital card with an existing card; update a digital card and user profile information; to share cards with others; to record relevant action and geographic location data, comprising a server application, a front-end for end-users and/or card-issuers, and/or a mobile device application. The website enables operations on the cards and interacts with social network applications. The website platform also allows card-issuers to access behavioral and consumer data of their program members. The mobile device application stores card data and interacts with systems and devices at points of sale and identification points, such as bar code scanners or cameras. The network application, can be used in open, public, social interaction websites or in private, community websites, to share cards or exchange card and loyalty program information.

### BACKGROUND

1. Technical Field

The invention relates to computer programs, systems and methods for implementation of a mobile platform for loyalty programs and cards, meant to store, access and manage the equivalent data as for physical cards and to turn cards mobile, while enabling data-related actions on the cards, by which promoting customer engagement with loyalty programs and membership organizations.

2. Background Art

The proliferation of loyalty programs and membership affiliation programs has lead to the accumulation of plastic and paper cards in wallets, weighting in them and making the programs uncomfortable to use. Cards and associated benefits and promotions (vouchers, coupons, etc.) are frequently forgotten, thus are not used, creating customer dissatisfaction.

Accordingly, there is a need for a system and method for the implementation of a mobile platform for loyalty programs and cards that engages customers and members with organizations, while adding mobility, comfort and simplicity to that relation, increasing customer satisfaction, brand awareness, loyalty program usage and consumer spend.

### BRIEF SUMMARY

The invention relates to computer programs, systems and methods for implementation of a mobile platform for loyalty programs and cards, meant to store, access and manage the equivalent data as for physical cards and to turn cards mobile, while enabling data-related actions on the cards, by which promoting customer engagement with loyalty programs and membership organizations.

Mobile devices such as mobile phones and PDAs offer the possibility to manage equivalent data as for physical cards, storing them and allowing identification of the holder. They are also communication devices that can input/output data such as to receive promotional offers, as coupons and discounts.

The adoption of social websites and services has created a large communications space where customers and members communicate and exchange opinions, frequently about products, brands and organizations. Organizations are now trying to communicate in the most personal way with their customers and members, using mobile devices and social websites. Furthermore, several organizations allow social actions with their programs, such as card sharing using key ring cards, for instance.

Accordingly, there is a need for a system and method for the implementation of a mobile platform for loyalty programs and cards that engages customers and members with organizations, while adding mobility, comfort and simplicity to that relation, increasing customer satisfaction, brand awareness, loyalty program usage and consumer spend. This invention can be configured to fulfill the outlined needs by enabling consumers to access their cards information and details, to access and make use of coupons and promotional offer data in their mobile phones, while allowing them to share digitally these pieces of data with other consumers.

### BRIEF DESCRIPTION OF THE DRAWING

FIG. 1—Three platforms of an embodiment of the invention interconnected for the management of loyalty, membership and identification cards.

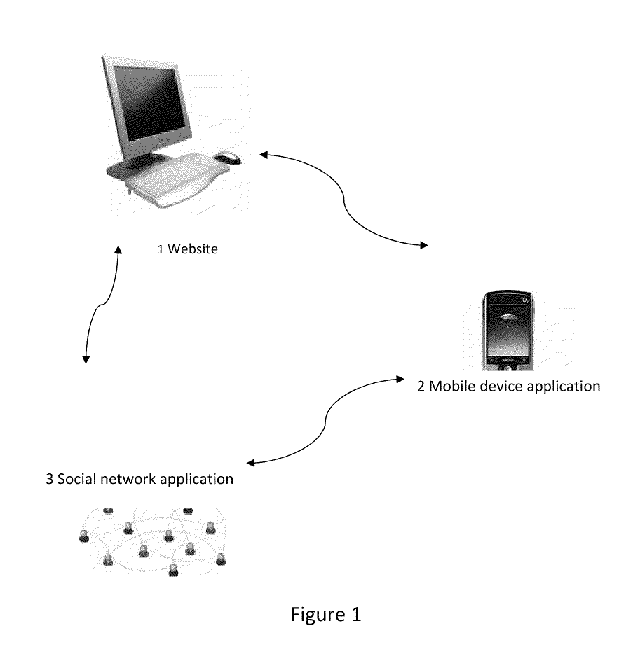

FIG. 2—Overview of an example of full implementation.

FIG. 3—Overview of a process for namely card signup, digital card issue, synchronization with cellphone, and card-issuer validation.

FIG. 4—Overview of a process for namely temporary digital card issue.

FIG. 5—Overview of a process for namely exchanging card and user profile information updates with card-issuers.

FIG. 6—Overview of a process for namely modifying card authorization profile, synchronizing information with new user and activating new digital card.

FIG. 7—Overview of a process for namely storing, retrieving and analyzing usage data, namely relevant actions and location.

### DETAILED DESCRIPTION

The website platform (1) can include a user front-end (203) and a card-issuer front-end (204). The user front-end (203) is available to all users, here designated as any individual that registers to use the invention, where they can perform several operations, as described in “Invention usage”. The card-issuer front-end (204) is available to card-issuer users (215), where they can perform the operations listed in “Invention Usage”. The website platform can be used to perform several operations on cards (as listed in “Invention Usage”, which includes card registration, new program sign up) and to interact with the social network application (e.g.: card sharing). The website platform (1) also allows card-issuers to, namely, access behavioral and consumer data of their program members and other users of the invention.

The mobile device application (2) comprises a program for mobile devices that stores cards and card associated data. The mobile application (201) is also able to interact with systems and devices commonly used at points of sale and identification points in physical facilities, such as bar code scanners, cameras and other devices used at payment points and identification points. This allows the identification of the individual and the execution of context-associated actions, such as door opening and access granting, and loyalty programs point management, such as new program sign up, account summary update, and points operations, such as points balance display and point accumulation and redemption. The mobile devices can be mobile phones, PDAs, smartphones, handheld music players and other mobile electronic devices that are able to connect to the internet, using 3G, UMTS, GPRS, EDGE, WiFi and other available protocols. The application can easily be made available for different mobile operating systems, including but not limited to JAVA/MIDP1 enabled systems, systems that support JAVA virtual machines, Linux-based systems, Symbian, Maemo, Windows Mobile, iPhone OS, Android, Palm OS and Blackberry OS, in current and future versions of these mobile operating systems.

The network application (3), namely social network application (3), can be used in open, public, social interaction websites or in private, community websites. Besides the social network application, the invention can also link to existing social networks through data interfaces and specific actions that can be triggered by the invention to the social network application.

### Exemplary Implementation Description

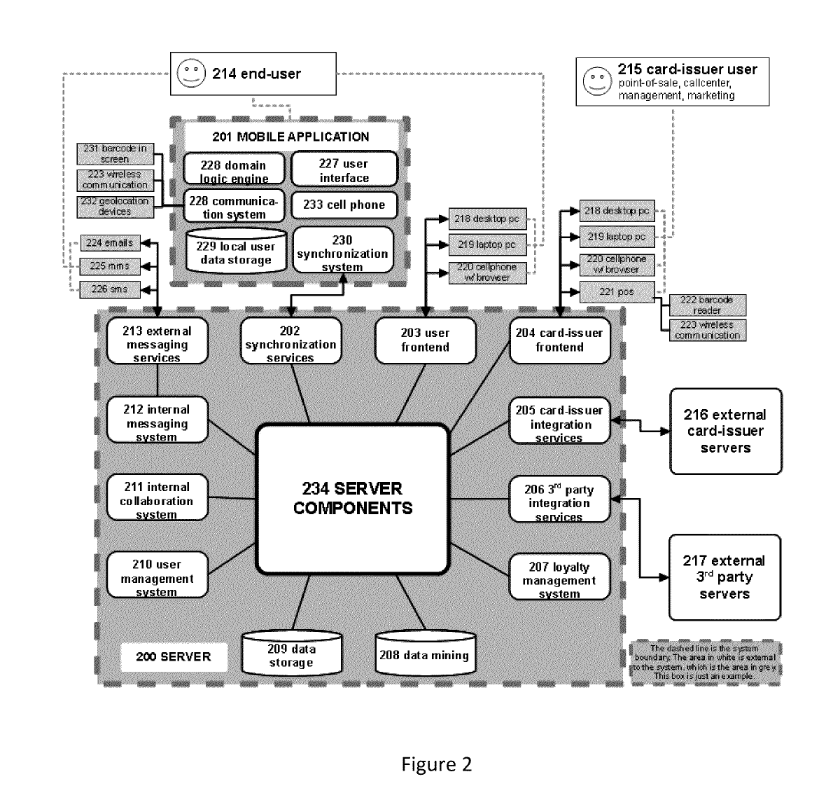

The system can be divided in two main parts: Server (200), and Mobile Application (201). They interact between themselves and also with other external systems. The following sections contain a detailed description of these parts. FIG. 2 depicts the full system.

It should be clear that any or all parts of the present invention that mention software or computer program, can also be understood as including firmware and/or hardware, such as a processor and/or data processing capabilities, which can include one or more microprocessors, integrated circuits, FPGA's, optical processor's, etc. . . . with memory adequate for controlling the operation of such processors, specific to the application.

The system itself may be implemented on any standard or custom web server, namely a LAMP configuration or equivalent proprietary solution.

Server (200)

The Server (200) is the core of the system, and can be accessed both by end-users (214) and card-issuer users (215), namely through a website interface, using different entry points. The main components of the Server (200) are:

Synchronization services (202) module—responsible for the communication between the Mobile application (201) and the Server (200) (in the Server part). Synchronizes any user and application data changes between both in an efficient way. The fact that the data is stored both locally and in the Server (200), means the Server copy works as a backup for any situation where the cellphone itself may be lost or damaged.

User front-end (203) module—this is the main entry point (apart from the specialized Mobile application (201)) for the end-user (214) to access the functionality in the system that is targeted for him/her. Most significant functions are: full account management, full card management, full communication, full opportunities and offers. The end-user (214) may select from several types of devices to access this front-end. Examples: desktop computer, laptop computer, cellphone with internet browser.

Card-issuer front-end (204) module—this is the entry point for the card-issuer users (215) to access the functionality that is targeted for card-issuers (215). Card-issuer (215) functionality may be relevant to different types of roles: point-of-sale (example: loyalty points accumulation and redemption), callcenter (example: validation of user data), management (example: data analysis) and marketing (example: client communication). The card-issuer user (215) may select from several types of devices to access this front-end (204). Examples: desktop computer, laptop computer, point-of-sale device, cellphone with internet browser. Some of these devices may use external hardware to increase the usefulness of the system. Examples: easy communication with the Mobile application (201) may be done using means of short-range wireless communication, and also by reading barcodes displayed in the Mobile Application (201) display.

Card-issuer integration services (205) module—provides services that allow for automated interaction between the Server (200) and external card-issuers' servers (216), for data exchange regarding registered members of the loyalty/membership programs. Examples: client data validation, loyalty account data synchronization, automated client creation.

Third-party integration services (206) module—provides services that allow for automated interaction between the Server (200) and external 3^{rd} party servers (217), in order to increase the service usefulness. Examples: social networking, product data mining.

Loyalty management system (207) module—contains the logic entities and operations that describe the contents of the users' accounts and loyalty programs.

Data mining (208) module—specialized data storage and data mining operations for business intelligence or operational decision support. The information is processed by the server (200) and delivered to user/card-issuer or other third parties namely using web or mobile interfaces.

Data storage (209) module—responsible for the safe storage of the data in the system.

User management system (210) module—contains the logic entities and operations that allow creating and managing the types of user accounts.

Internal collaboration system (211) module—allows users of the system to interact between themselves. Examples: suggestions, trading.

Internal messaging system (212) module—provides communication between the users, inside the system. Several modes are available: one-to-one, one-to-many. The latter is especially relevant for messages from the merchants to their clients (end-users in this system). Messages can be sent and received from the system itself.

External messaging services (213) module—augments the functionality provided by the internal messaging system, allowing bi-direction communications to and from external communication channels. Examples: card-issuer sends MMS or SMS to end-users (214)′ cellphones; user sends SMS to produce some action on the service; service sends email to several end-users (214)′ inboxes.

Mobile Application (201)

The Mobile application (201) executes on the end-user (214) cellphone, and provides a specialized way of accessing the user's account and data, focusing on being available at any time or place (in the user's cellphone, even if he/she doesn't have network coverage). It is implemented for several mobile equipments/operating systems platforms. Its main components are:

User interface module (227)—responsible for rendering the contents of the user account data and allowing interaction and actions with the data. Depending on the limitations of the cellphone, different levels of functionality may be available. Some cellphones may provide a smaller or larger subset of the functionality available from the Server's end-user front-end (203).

Domain logic engine (228) module—contains the logic entities and operations that describe the contents of the user account.

Communication system (228) module—establishes connections to external devices and systems that provide extra functionality. Examples: barcode rendering in screen (231), to allow easy interaction with card-issuers' point-of-sale systems; wireless communication 223), to allow direct communication with other users or card-issuers in the same physical location; geolocation devices (232), to allow for specific operations, relevant to the physical location of the end-user (214).

Local user data storage (229) module—stores the data needed for executing the most relevant functionality of the mobile application (201) in disconnected mode, i.e. without a permanent connection to the Server (200), which holds the user account data.

Synchronization system (230) module—responsible for the communication between the Mobile Application (201) and the Server (200) (in the Mobile Application part). Synchronizes the user data changes between both in an efficient way. The fact that the data is stored both locally and in the Server (200), means the Server copy works as a backup for any situation where the cellphone itself may be lost or damaged.

### Exemplary Operation

Invention usage relies on specific cases for the three different platforms and the different users (general users and card issuers). The specific cases are depicted in the following table.

| | | Card |
|---|---|---|
| | End-User's (214) actions | issuer's (215) actions |
| Website (1) | New card sign-up | Card-issuer's action |
| | User data update | on cards |
| | Own card creation | Card-issuer |
| | Card sharing | communication |
| | Card suggestion | Data mining |
| | Card feedback | |
| | Card deletion | |
| | Operations on points | |
| | Communication from | |
| | card-issuers | |
| Mobile application | Download | Data mining |
| (2) | Internet access mode | |
| | (active/passive) | |
| | Mobile application | |
| | interaction in stores | |
| Social application | Card sharing | |
| (3) | Card suggestion | |
| | Operation on points | |

To use the invention, a user (214) may register to the invention, either through the invention website, or by any other mean that can access the invention in the internet, such as the mobile device application. The website holds a collection of loyalty, membership and identification cards, updated regularly. The user (214) can register physical cards he has in his wallet, searching them in the website collection, entering the details of the card, such as card number, expiration date, customer number, membership type, date of issue, and any other details on the card.

The user (214) can also create new cards that do not exist in the website database (209), and register all card data including uploading an image.

Each user (214) has a profile, in which he can enter personal data, such as demographics, affiliation, interests and other data that may be pertinent for contact with card-issuer users (215).

The invention allows users (214) to do multiple actions on their registered cards. These actions may be cross-platform, which means they can be performed on the invention's website, mobile application (2) and social application (3), or exclusive to one of these platforms. The actions that can be performed include:

New card sign up—The invention allows users (214) to sign up to new cards from card-issuer users (215) and receive the card on their mobile device (called mobile card). The mobile card is directly sent to the user mobile device, so that he can identify himself at the card-issuer's physical facilities, as well as in card-issuer partners' facilities, where the card is accepted as a means to access benefits. The invention also allows the user to subscribe the new card without completing a form, as it gathers the necessary elements from the data previously input in his profile. Therefore, the invention can be configured to automatically transform the data in the fields that are already in the user's profile. The user may only fill in fields that are not included in his profile data.

User data update—The invention also can be configured to allow users (214) to update personal data on their profile and consequently choose to inform the card-issuers regarding those changes. These changes are automatically updated in card-issuers' databases.

Own card creation—The invention also can be configured to allow users (214) to register cards that are not present in the website's collection, inputting the card's name and the card or customer number, and any other relevant data, as applicable. He may also upload a card picture, allowing him to easily identify the uploaded card. To simplify this task, and avoid repetition of cards, a suggestion mechanism is in place, suggesting cards with similar names to the user.

Card sharing—The invention can be configured to allow the user (214) to share his own cards with other users. This can be done either using solely the website (1) or the mobile application (2), or websites where social interactions can take place (3). Users (214) can also share cards with non-users of the application, either through the inventions' website (1) or through a social network service, in order to accept a shared card, that non-user will have to register to use the application. By sharing a card with another user, the owner of the card is allowing the other user to use the card on his behalf, thus collect points or any other type of benefits, as long as the card-issuer user (215) allows usage of shared cards.

Card suggestion—The invention, through its social application (3), can be configured to allow the user to suggest cards to users and non-users. Shall the suggestion be accepted, this triggers a new program subscription sign-up and the creation of the mobile card.

Card feedback—The invention can include a feature for the user (214) to provide feedback on a mobile card usage in a store or service. This feedback can be given at any time, as a positive or negative feedback, whether the card was accepted or not by that company. A small text can also be attached. The result of this feedback is visible to users (214) as a symbol that reflects an average of the entire card's feedback given over time; the feedback can be given on the website (1), through the application (2) in the mobile device, or through the invention social application (3), and can be shared in social networks.

Card deletion—The invention can be configured to allow the user (214) to delete registered cards. Deleting a card means that either the user is no longer going to use that card or that he wants the company that issued the card (215) to know that he is dropping use of the card and unregistering from its database.

Operations on points—The embodiment of the invention, in the website (1), can be configured to allow users to check loyalty points' balances for the cards they have. Users (214) can exchange loyalty programs' points (miles or any other loyalty rewarding system) between cards from different card-issuers, and also give, trade, buy and sell at an established rate, and auction loyalty programs' points with other users. All these operations are available between cards and card-issuers (215) that agree to allow users (214) to perform them.

Card-issuer communication-users' side—The invention also can be configured to allow users (214) to receive messages from card-issuers (215) from which they are customers (i.e., from which they have a registered card), via the invention's message center (212), a message box within the website. They can act upon these messages, sending them to the mobile application (201), to the social web application, and to users of social interaction websites. Users can also receive communication through SMS, MMS or other means the mobile device supports.

Card-issuers' actions—Using the website's card-issuer front-end (204) or any automatic mean of communication (including, but not limiting to web services and APIs), the invention can be configured to allow card-issuers to issue cards to users, sending them directly to the user's mobile device, without issuing a physical card. In the same way, card-issuer users (215) can validate, re-issue, and expire cards, authorize card sharing, update account point balances, and upgrading or downgrading loyalty cards within program categories. The card-issuer front-end (204) also allows card-issuers to change their card image.

Card-issuer users (215) can be warned of changes in a user profile and have their customer databases automatically updated.

Card-issuer users' (215) communication—The card-issuer front-end (204) of the invention can be configured to allow card-issuer to communicate with users that have their card registered, through the invention's message center (212, 213), sending an electronic message to the user's account, through SMS, MMS and other electronic means the mobile device supports. Card-issuer (215) can also communicate with users that do not have their card, and hence are not customers. The invention can be configured to allow this through database (208, 209) mining according to users demographics and interests parameters, as introduced in the user profile.

Mobile application (201) download—In order to identify himself in a store/organization, the user needs to download the mobile application (201) to his mobile device. This operation is done using alternative methods, which include: through the internet in the mobile device, accessing the invention mobile download page through a mobile web browser; downloading the application installation file to a computer, and then transferring it to a mobile device using the mobile device's data cable; download through a mobile application store (including, but not limited to, mobile carriers and mobile phone's branded application stores); soliciting to receive a text message (SMS) to the mobile device with a wap push link to download the application.

Mobile application (201) internet access—The mobile application (201) can operate in an active mode (always active internet connection), accessing regularly and automatically to the invention's server (200) and synchronizing the application to receive cards and messages, or in a passive mode, accessing to the invention's server (200) only on user's action.

Mobile application (201) interaction in stores—The mobile application can interact in stores and organizations physical locations using one-dimensional bar codes, quick response codes, infrared technology, Bluetooth, Near Field Communication, Wi-Fi or any other communication methods the mobile device has enabled. This interaction includes user identification; communication to update loyalty programs points' balances (including miles and other rewarding systems), suggestions to users, promotion awareness warnings and any other communication included in the scope of loyalty programs.

Data mining—Card-issuers (215) can have access to consolidated data (209) and advanced analysis services (208) regarding their card program members which are users (214) of invention. The data card-issuers (215) can access are related to members profile information (including demographics and preferences), cards registered and geo-referenced behavior of card usage in store, card access when in competitors' stores, and in situ visualization and usage of offers. The data to be accessed are related to own cards/offers and competitors' cards and offers.

Social network application (3)—In addition to the previously described actions that can be performed in the social application, users (214) can also notify their network in the social networking website of auctions they are holding, show their interest, bid and share their bid and share actions performed in the website with their point balance. Through the social application (3), a user (214) can advertise his status upgrade in a loyalty program, share his cards, and share new program subscriptions.

### Exemplary Advantages and Uniqueness

An example of invention uniqueness can lie in namely two aspects: its social interaction and its central data storage and processing mechanisms for loyalty and membership consumer data. It connects people that are customers and members of card-issuer organizations with each other, by performing social actions on cards and associated points, as described in [Card sharing], [Card suggestion], [Card feedback], [Operations on points], and [Social application]. The invention can also be configured to connect people to card-issuer organizations (e.g. [User data update], [Card-issuer communication-users' side], [Card-issuer users' (215) actions]) using simultaneously three platforms: the website (1), the mobile application (2) and the social application (3). These actions are distinctive of other solutions now available, as they provide ways of sharing card information and program-related information between current and prospective users of the invention. They also provide ways of sharing information on mobile card acceptance by a card-issuer organization.

The invention can include an implemented set of data operators and validators:

a data validator for data structures when conducting any interface operations, namely with card-issuers systems or card-issuer initiated actions;

a data adaptor for data structures when conducting any such interface operations, namely with card-issuers systems or card-issuer initiated actions;

a data operator for adapting data structures when conducting any complex change such as updating card ownership records for pre-existing card association, new card issuances or card-related information updates;

a data operator for adapting authorization data structures when conducting any complex change to card permissions, such as sharing with other users;

a data operator for adapting card point data structures when conducting any complex change to card point balances, such as accrual, remission, transfer, purchase and/or sale;

The website platform (interface to access the central data storage and processing mechanisms for loyalty and membership consumer data), housing a directory of loyalty programs and membership cards, makes the invention is distinctive from other applications that allow the digital management of loyalty programs in mobile devices. Therefore, unlike other solutions that allow card storage in a mobile device, as taking a picture of the card with a digital camera and associating a number, the invention is not a repository of cards.

The invention may be considered unique in the way that it stores cards, programs and users' information, enabling users to backup all their information and accessing them everywhere.

The invention can be distinctive from organization centered applications, where it is the organization that drives the usage of a virtual card in a mobile device. These applications are not meant for usage with other cards from other organizations. The application is distinctive in the way it combines the individual and the corporate usage of loyalty programs, through a worldwide, multi-card multi-organization platforms.

By allowing users to subscribe to new programs without completing a form (either paper-based or digital), reusing information already introduced in the user's profile, the invention can be configured to enable users with a less fastidious process for new programs sign-up. The invention can also be a process for users to sign up to programs in a totally paper and plastic free way, while receiving immediately a mobile card on their cell phone.

Having established communication channels between the invention platforms and card-issuers' systems, users' profile data is shared automatically with card-issuers, which allows the invention to notify immediately card-issuers of users' profile changes, such as address data or phone number, enabling card-issuers to maintain updated customer's data.

The same communication channels also enable card-issuers to update loyalty programs' points balance, enabling users to check them, and act on them by auctioning, giving or trading them.

The invention can be configured to enable card-issuers to mine the users' database for several parameters (e.g. users demographics, location, interests), and target current program members and non-members with specific promotional and informative messages. This is distinctive from current solutions to store cards in mobile devices, as it allows communication streams between card-issuers and their members and non-members through the invention's platforms.

The invention can also be distinctive from other applications that allow digital card storage as it allows users and card-issuers to suggest cards to other users; based on potential interest to the user the card is being suggested.

Through its geo-referencing user behavior data mining system, the invention can provide unique insights to card-issuers on its program members behavior when in its own physical facilities and its competitors physical facilities, particularly in stores.

### Usage Example 1

This example is focused on the process of creation of an end-user (214) account, and basic usage of the service for that user:

The end-user (214) connects to the Server's end-user front-end (203):

He/she introduces the information needed to create a new account.

Then, he/she selects one of his/hers physical loyalty cards (it shall be referred as card A in this example) and introduces the data needed to manage the equivalent data as for a physical card in the system. The mobile card A is created at this point. It is possible to access the data regarding the card A from the Server end-user (214) endpoint only.

He/she follows the available instructions for installing the Mobile application (201) in his/hers cellphone.

After successfully installing the Mobile application (201) in the cellphone, the end-user (214) opens this application:

He/she is asked to provide credentials to be identified in the service.

The data in the Mobile application (201) is synchronized with the Server (200). At this point it is possible to access the data regarding the card A from the Mobile application (201).

He/she selects another of his/hers physical loyalty cards (card B) and introduces the data needed to manage the equivalent data as for the physical card in the system, now via the Mobile application (201). The mobile card B is created at this point. It is possible to access the data regarding the card B from the Mobile application (201) only.

The data in the Mobile application (201) is synchronized with the Server (200). At this point, card B is also available (and backed-up) in the Server (200).

The end-user (214) may return to the Server's end-user (214) endpoint at any time (parallel usage of the Mobile application (201) and the Server (200) is supported):

He/she can browse his/hers virtual cards. Two mobile cards are available in the account at this point: card A and card B.

The user can edit the info of card B.

The end-user (214) may go back to the Mobile application (201):

The data in the Mobile application (201) is synchronized with the Server (200). At this point, the change made to card B becomes available in the Mobile application (201).

### Usage Example 2

This example is focused on the process of signing-up to a new loyalty program:

The end-user (214) is located in the store of a card-issuer that is a member of the service. The end-user (214) is not a member of that card-issuer's loyalty program, and wishes to join. The end-user (214) is already a member of the invention. The end-user (214) opens the Mobile application (201):

He/she selects the option to join the card-issuer's loyalty program (he may be aided in that task by the use of integrated geolocation services). For that purpose, he/she needs to provide some personal information (typically filling up a form in the Mobile application (201)). The system may aid the end-user (214), by automatically filling in fields that are already known.

The end-user (214) confirms that he/she wants to create the card.

At this point, the Mobile application (201) communicates this action to the Server (200). The Server (200) may then communicate with the card-issuer's Server (216) (via the Server's card issuer integration services (205)), requesting the creation of a new client account. The information regarding this account is then stored in the Server (200) and synchronized to the Mobile application (201) of the end-user (214). It is important to notice that from the confirmation of card creation to the end of this step, a few seconds should have elapsed, so that the end-user (214) can benefit from the new account right away. A mobile card (card C), corresponding and equivalent to a potential physical card, becomes available both in the Mobile application (201) and the Server end-user endpoint (203).

The created account may be manually validated later, by the card-issuer's staff (via the Server's card-issuer front-end (204)). If the data sent by the end-user (214) is in any way incomplete or incorrect, the system may ask for this data to be corrected; or as a last resort the mobile card C may be canceled by the card issuer.

### Usage Example 3

This example is focused on the communication mechanisms available to the card-issuer:

A card-issuer user (215) logs in the system via the card-issuer front-end (204). This user may be a part of the card-issuer's marketing team, and wants to create a campaign for its clients:

He/she filters the list of clients (that are registered end-users (214) in the service) according to available and predefined parameters, then writes a message that is to be delivered in the end-user (214) in-service inbox. This message is sent via the Server's internal messaging system (212). The end-user (214) will receive this message and can reply back to the card-issuer, if desired.

The card-issuer user (215) then filters the list of clients by a different parameter, and writes a different message to be sent to this group of users. Also, as this group of users shares some different characteristics, it may be more relevant to send SMSs to the end-users (214)′ cellphones instead of messages to their in-service inboxes. This is also sent via the Server's internal messaging system (212), which in turn may use the external messaging services (213) to send the SMSs.

### PROCESS EXAMPLES

### Example 1

### User Sign Up

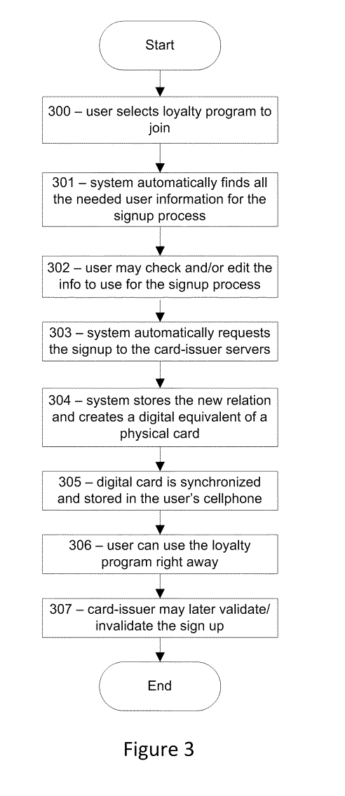

This process allows the user (214) to instantly signing up to a loyalty program, having no previous relation with the card-issuer (215) (FIG. 3).

300—The user connects to the server user front-end (203) or the mobile application user interface (227), and selects the loyalty program he/she wants to join. For this, he/she uses the loyalty management system (207), which in turn uses the data stored in the service data storage (209). If this is being done from the mobile application (201) in the user cellphone (233), the communication between the mobile application (201) and the server (200) is done via the synchronization system (230) and the synchronization services (202).

301—The loyalty management system (207) starts the signup process, on behalf of the user. It collects the user personal data, which is needed for the signup process. The user management system (210) is the responsible for this operation. It fetches the data storage (209) to discover all the data the user previously introduced to sign up to other loyalty programs, or to use other features of the service.

302—The user may verify all the data that the system gathered for the signup process. This data may be mandatory or optional for signing up to the selected loyalty program. At this point the user may select not to provide some or all of the optional data to the card-holder. He/she may also decide to cancel the current operation. The user may also edit the data, to correct it or to complete it.

303—The loyalty management system (207) uses the card-issuer integration services (205) to make a request for the card-issuer servers (216) to automatically signup the user in its loyalty program, returning a generated number, to ID the user in its relation with the card-holder. The card-issuer servers (216) may have automatic validation rules executing at this point, which can deny the user request for sign up.

304—The loyalty management system (207) creates and stores all the information of the new relation between the user and the card-issuer, and creates a digital equivalent of a physical card that the user can use to identify him/herself for any purposes the card-issuer allows him/her to. The data is stored in the system data storage (209).

305—The system synchronizes this new digital card to the mobile application (201) in the user cellphone (233), via the server's synchronization services (202) and the mobile synchronization system (230). The data is then stored in the cellphone (233), in the local user data storage (229), allowing the digital card to be used even when a connection to the server (200) is not possible.

306—At this point, the user may use the loyalty program, using the digital card in the mobile application (201) to identify him/herself as a member. He/she may even use a method like a barcode on the screen (231)—available via the communication system (228)—to quickly identify him/herself with an electronic system. It is worth noting that the transition from the manual step in (302) to (306) is almost instantaneous from the user point of view—assuming no connection problems exist outside the system boundaries, i.e. between (202) and (230); (205) and (216).

307—The card-issuer may later have a validation step, in which he/she may cancel the user sign up due to any conditions that could not have been automatically verified in (303). This may be done via the communication link between the card-issuer servers (216) and the system's card-issuer integration services (205); or via the card-issuer front-end (204).

### Example 2

### User Pre-Signup

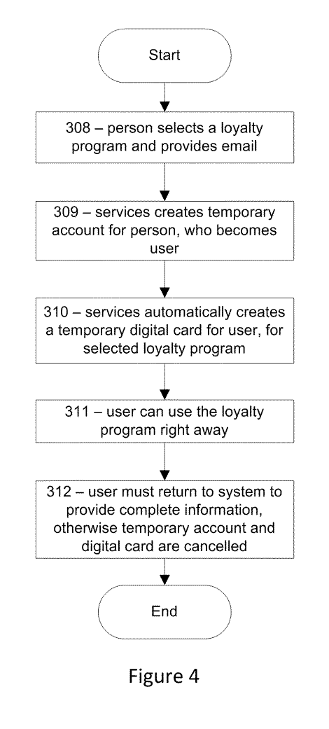

This process allows any person with a cellphone to instantly sign up both to a loyalty program and to the service, having no previous relation with the card-issuer (215) and the service (FIG. 4). This may be done from anywhere, and is especially relevant if the user (214) is in a store, completing a purchase, and decides that joining the loyalty program would be positive for him/herself.

308—The person uses his/hers cellphone (233) to access the mobile application user interface (227), and select the loyalty program he/she wants to join. He/she only needs to provide his/hers email at this point. The communication between the mobile application (201) and the server (200) is done via the synchronization system (230) and the synchronization services (202).

309—With the data provided in (308), the system is able to create a new user (214) account, by means of the user management system (210). The new account info is then stored in the data storage (209). This account is temporary and must be confirmed later by the user (214), who is warned about this fact at this point. The person becomes a service user.

310—At this point, the regular process of signing up a user (214) with a loyalty program (as described in the previous section) takes place: steps from (300) and (307). The only differences in this process are: the automatic validation rules (303) in card-issuer's servers (216) must be able to allow sign ups from temporary accounts; and the manual validation process from the merchant (307) may only take place when the system has the needed info regarding the user.

311—At this point, the user (214) may use the temporary account and digital card to identify him/herself to use the benefits from the loyalty program. It is worth noting that the transition from the manual step in (308) to (311) is almost instantaneous from the user point of view—assuming no connection problems exist outside the system boundaries, i.e. between (202) and (230); (205) and (216).

312—The user (214) must return to the system later within a specified time limit, to provide the data needed for both the signup in the system and in the loyalty program, and to confirm the email address provided in (308). If the user (214) fails to complete this step, both the temporary account and sign up to the card-issuer loyalty program are cancelled.

### Example 3

### User Information Change Notification

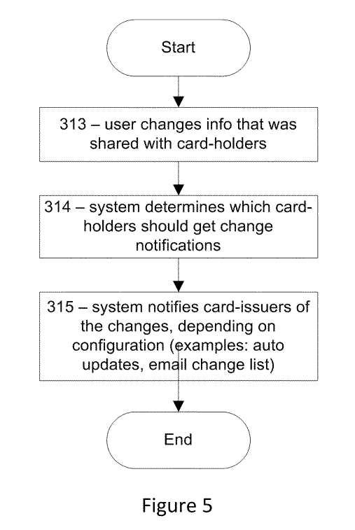

This process allows notifying automatically all the card-issuers (215) with whom the user has loyalty relations, regarding changes made to information being shared by the user (214) to the card-issuers (FIG. 5).

313—During its usage of the system, the user (214) produces changes to the information he/she shared with the card-issuers (215) (for instance, when he/she signed up with their loyalty accounts). These changes are made through the user management system (210), and stored in the data storage (209).

314—After the changes are done, the user management system (209) has the responsibility to inform the card-issuers (215) about the changes made to the data relevant for them (the data which the user authorized to share with them). To determine these relations it uses the loyalty management system (207).

315—The system then proceeds by informing the card-issuers (215), using the methods configured by them. Some card-issuers (215) may have configured automatic mechanisms for user data update, with communication between the service server (200) and the card-issuers' servers (216), via the card-issuer integration services (205). Alternatively, the card-issuers may have configured a simpler notification method, like sending a weekly change list email (224), via the external messaging services (213), which is part of the internal messaging system (212).

### Example 4

### Card Sharing Between 2 Users

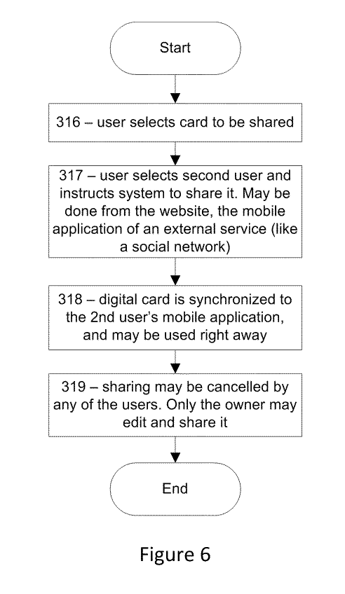

This process allows one of the users to share one of his cards with another user, granting him the possibility of also being identified with the loyalty program, and sharing its benefits and allowing for joint point accumulation (if available) (FIG. 6).

316—The user (214) selects one of his/hers digital cards, to be shared. This selection is done using the loyalty management system (207).

317—The user (214) then selects another user and instructs the system to share the selected card with this second user. The sharing operation is done using the internal collaboration system (211). It may be ordered from either the server user front-end (203); the user interface (227) of the mobile application (201)—via the synchronization system (230) and synchronization services (202); and from an external social network which is connected to the service by the communication between the social network servers (217) and the third-party integration services (206).

318—The digital card becomes available to the second user, both from the user front-end (203) and the mobile application's (201) user interface (227)—after synchronization via the synchronization services (202) and the synchronization system (230).

319—Any of the users may cancel the sharing, but only the owner of the digital card may edit, delete all instances and share the card with other users.

### Example 5

### Geo-Referenced User Behavior Data Mining

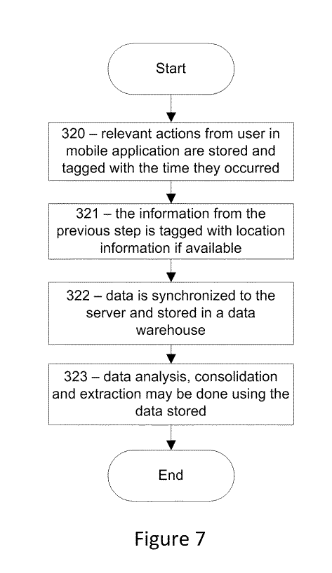

This process allows the service team and also card-issuers to have access to consolidated data and advanced analysis services regarding their users (FIG. 7).

320—Some relevant actions that the user does from the user interface (227) of the mobile application (201) are stored in the local user data storage (229), together with some parameters, and the exact time of the action.

321—The mobile application (201) uses its communication system (228) to get location information from any available geolocation devices (232). Example of devices: GPS, cell information from the network, etc. This information is attached to the data stored in (320).

322—This data is synchronized to the server (200), via the synchronization system (230) and the synchronization services (202). In the server-side (200) the data is then stored in the data warehouse of the data mining module (208).

323—Data analysis, consolidation and extraction are done by the data mining module (208), and may be requested and configured from the card-issuer front-end (204) or the card-issuer integration services (205).

What is claimed is:

1. A loyalty, membership and identification card system for a mobile application on a mobile device, the system comprising:
a data storage server module to store data at a server in the system;
an end-user front-end programmed module for a mobile application to enter or to request card information;
a synchronization services programmed module to communicate between said mobile application and said data storage server module;
a card-issuer front-end programmed module to enter said card information or to request issuance of a card;
a processor to calculate, compare, adapt or transform said card information, according to at least one of said modules;
an output to display said card information calculations, comparisons, adaptations or transformations.

2. The system of claim 1, further comprising:
a loyalty management system programmed module to store at least one logic entity or operation corresponding to a user account for said card.

3. The system of claim 1, further comprising:
a card-issuer integration services programmed module, coupled to a card-issuer server, to allow for automated interaction between said server and said card-issuer server.

4. The system of claim 1, further comprising:
a third-party integration services programmed module, coupled to a third-party server, to allow for automated interaction between said server and said third-party server.

5. The system of claim 1, further comprising:
a data-mining programmed module to process specialized data storage or to perform data mining operations.

6. The system of claim 1, further comprising:
a user management system programmed module to create and manage a user account for said card.

7. The system of claim 1, further comprising:
an internal collaboration system programmed module to allow a user of said mobile application to interact with another user.

8. The system of claim 1, further comprising:
an internal messaging programmed module, coupled to an external messaging services programmed module, in turn coupled to email or wireless text message or multimedia wireless message services, to provide communication between users of the system.

9. The system of claim 1, wherein said mobile application further comprises:
an user interface programmed module to allow interaction with the data at the server;
a synchronization programmed module to allow communication between said mobile application and said server;
a local user data storage module to store the data to execute a function of said mobile application in a disconnected mode;
a communication system module, to establish a connection to a barcode displayer, a wireless communication system, or a geographic location system;
a domain logic engine module to access contents of a user account;

10. A computer-implemented process for operating server modules to associate an existing card with a loyalty, membership and identification card system using a mobile application, the method comprising:
retrieving information of said existing card for user profile completion from a server;
providing a user with choice to edit and verify said information;
sending said information to a card-issuer requesting card association and validation;
receiving response data from said card-issuer;
applying a data validation operator and a data adaptation operator to said response data,
updating user profile and card ownership records; and
adapting and synchronizing said user profile and card ownership records with a mobile device, thereby enabling digital card use by said user.

11. The process of claim 10, further comprising the steps to sign-up and use a new digital card by:
providing said user with a loyalty program to join;
retrieving information for signup from a user profile;
providing said user with choice to edit and verify said information;
providing said user with fields to fill in data not included in the user profile;
transforming the data to the corresponding card-issuer fields;
sending said information to said card-issuer requesting card-issue;
receiving response data from said card-issuer;
applying the data validation operator and the data adaptation operator to said response data, and updating the user profile and card ownership records; and
validating card ownership and user profile with said card-issuer.

12. The process of claim 10, further comprising the steps to sign-up and use a new temporary digital card by:
providing said user with a loyalty program to join;
providing said user with a temporary account and digital card, thereby enabling digital card use by said user;
retrieving information for signup from said user;
providing said user with a choice to edit and verify said information;
sending said information to said card-issuer requesting definitive card-issue;
receiving response data from said card-issuer;
applying said data validation operator and said data adaptation operator to said response data, and updating user profile and card ownership records;
adapting and synchronizing said user profile and card ownership records with said mobile device, thereby enabling definitive digital card use by said user;
validating said card ownership and user profile with said card-issuer.

13. The process of claim 10, further comprising the steps to update digital card and user profile information by:
retrieving updated information from said user;
applying said data validation operator to verify the validity of said updated information;
applying said data adaptation operator to adjust the updated information to the card-issuer specifications;
verifying which card-issuers are to be notified, from pre-configuration settings;
notifying said card-issuers of said updated information.

14. The process of claim 10, further comprising the steps to share a first user card with a second user:
providing said first user with a choice of card to be shared;
providing said first user with said second user to share the card with from a social networking site, an external service, or a mobile application for an external service;
applying said data validation operator and said data adaptation operator to second user profile and card ownership records;
adapting and synchronizing said second user profile and card ownership records with a second user mobile device, thereby enabling digital card use by said second user;
validating said card ownership records and second user profile with said card-issuer.

15. The process of claim 10, further comprising the steps to record relevant action and geographic location data by:
recording user actions and geographic location data in said mobile device application;
synchronizing said data with the server, thereby keeping said data in the storage module.

16. A computer program product for loyalty, membership and identification cards, wherein said computer program product comprises a computer usable medium having computer usable program code executable by a processor embodied therewith, said computer usable program code being configured to have a computer:
record end-user actions and geographic location data in a mobile device application on a mobile device; and
communicate with a server in order to:
associate an existing card;
sign-up and use a new digital card;
update digital card and user profile information; and
share a first end-user card with a second end-user.

17. A computer program product for server operation of loyalty, membership and identification cards via a mobile device, wherein said computer program product comprises a computer usable medium having computer usable program code executable by a processor embodied therewith, said computer usable program code being configured to have a computer:
enable an end-user to sign-up and use a new digital card;
enable said end-user to sign-up and use a new temporary digital card;
associate said new digital card with an existing card;
enable said end-user to update digital card and user profile information;
enable said end-user to share first end-user cards with a second end-user;
record relevant action and geographic location data;
wherein said computer is coupled to an end-user front-end programmed module, or a synchronization services programmed module for a mobile application.

18. A computer program product for mobile device operation of loyalty, membership and identification cards, wherein said computer program product comprises a computer usable medium having computer usable program code executable by a processor embodied therewith, said computer usable program code being configured to have a computer:
interact with barcode scanners, cameras or other point of sale or identification systems, by displaying a picture or barcode, or by emitting a signal connected with identification of an end-user selected card;
enable an end-user to sign-up and use a new digital card;
enable said end-user to sign-up and use a new temporary digital card;
associate a new digital card with an existing card;
enable said end-user to update digital card and user profile information;
enable said end-user to share first end-user cards with a second end-user;
record relevant action and geographic location data;
wherein said computer is coupled to a synchronization services programmed module comprised in a server.
